(19) United States
(12) Patent Application Publication
(10) Pub. No.: US 2025/0390102 A1
(43) Pub. Date: Dec. 25, 2025

(54) Integrated Acceleration - Based Positioning

(71) Applicant: AGCO Corporation, Duluth, GA (US)

(72) Inventor: Wynter Storme Wiebke, Hesston, KS (US)

(21) Appl. No.: 19/243,346

(22) Filed: Jun. 19, 2025

Related U.S. Application Data
(60) Provisional application No. 63/664,019, filed on Jun. 25, 2024.

(51) Int. Cl. G05D 1/248; G05D 1/617; G05D 105/15; G05D 107/20; G05D 109/10; G05D 111/50

(52) U.S. Cl. CPC G05D 1/248; G05D 1/617; G05D 2105/15; G05D 2107/21; G05D 2109/10; G05D 2111/52

(57) ABSTRACT

An agricultural machine operable for guided or automated travel through a field via an integrated acceleration-based positioning system. The agricultural machine has a chassis having a left half and a right half and a plurality of wheels rotatably coupled to the chassis. The integrated acceleration-based positioning system includes a controller and two or more multi-axis accelerometers, with at least one of the multi-axis accelerometers mounted on the left half of the chassis and at least one of the multi-axis accelerometers mounted on the right half of the chassis. The controller is configured to receive signals from the multi-axis accelerometers and to calculate a real-time position of the chassis in the field based on acceleration signals received from the multi-axis accelerometers in a back-up mode when geographic location signals from the global positioning sensor are outside of a pre-determined acceptable range.

### CROSS REFERENCE TO RELATED APPLICATIONS

This application claims the benefit of the filing date of U.S. Provisional Patent Application 63/664,019, “Integrated Acceleration-Based Positioning,” filed Jun. 25, 2024, the entire disclosure of which is incorporated herein by reference.

### BACKGROUND OF THE INVENTION

Windrower machines and other agricultural equipment can be automated and/or guided by a user via GPS or other such global positioning technology. However, there are some equipment maneuvers that can lead to inaccurate global positioning readings or heading readings from the GPS, such as zero-turn maneuvers by the windrower machine when reaching the end of a row in a field. To deal with such situations, some prior art machines use a wheel displacement method (using wheel velocity) along with GPS positioning. However, such systems can also lead to error build up over time due to wheel slippage when traversing on a less than ideal medium (e.g., a muddy field).

Another disadvantage of traditional windrower machines is that there are no collision detection capabilities. Even in other vehicle safety systems with collision detection, such methods generally use cameras which are very data and processing intensive and can be very expensive.

### SUMMARY OF THE INVENTION

Embodiments of the current invention address one or more of the above-mentioned problems and provide a distinct advance in the art of agricultural machine guidance through a field. Specifically, an aspect of the present invention includes an agricultural machine operable for guided or automated travel through a field, including a chassis having a left half and a right half, a plurality of wheels rotatably coupled to the chassis, multi-axis accelerometers, and a controller. At least one of the multi-axis accelerometers is mounted on the left half of the chassis and at least one of the multi-axis accelerometers is mounted on the right half. The controller receives signals from the multi-axis accelerometers and calculates an instantaneous or real-time position of the chassis in the field based on acceleration signals received from the multi-axis accelerometers.

In another aspect, a windrower machine operable to perform a zero-radius turn includes a chassis having a left half and a right half, a plurality of wheels rotatably coupled to the chassis, a global positioning sensor, secondary sensors, and a controller. The global positioning sensor is configured to output geographic location signals, and the secondary sensors each include a three-axis accelerometer. At least one of the secondary sensors is mounted on the left half and at least one of the secondary sensors is mounted on the right half. The controller is communicably coupled to receive geographic location signals from the global positioning sensor and acceleration signals from the secondary sensors. The controller also calculates a real-time position of the chassis in a field based on the acceleration signals received from the secondary sensors when the geographic location signals are outside of a pre-determined acceptable range, such as during a zero-radius turn of the windrower machine.

Yet another aspect of the invention includes a method for accurately guiding an agricultural machine through a field, the method including the steps of receiving, with a controller, the following: 1) geographic location signals from a global positioning sensor located on the agricultural machine and 2) acceleration signals from at least two three-axis accelerometers located on opposing left and right halves of a chassis of the agricultural machine. The method also includes the steps or determining with the controller the following: 1) a real-time position of the chassis based on the geographic location signals in a default mode and 2) the real-time position of the chassis based on the acceleration signals when the geographic location signals are outside of a pre-determined acceptable range. The method may also include the step of sending the real-time position of the chassis to an automated guidance system or a user-guided navigation system communicably coupled with the controller for guiding the agricultural machine through the field.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a schematic plan view of a windrower machine having an integrated acceleration-based positioning system, in accordance with embodiments of the present invention; and

FIG. 2 is a flow chart of a method for guiding the windrower machine through a field, in accordance with embodiments of the present invention.

The drawing figures do not limit the current invention to the specific embodiments disclosed and described herein. While the drawings do not necessarily provide exact dimensions or tolerances for the illustrated components or structures, the drawings are to scale as examples of certain embodiments with respect to the relationships between the components of the structures illustrated in the drawings.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Embodiments of the present invention include an integrated acceleration-based positioning system used for an agricultural machine. The system is configured for additional data gathering as a redundancy with GPS positioning, using multiple sensors such as accelerometers/inclinometers mounted to a chassis of the agricultural machine. This redundancy gives an accurate, real-time heading for the machine, even when performing zero-turn maneuvers, such as is used with a windrower machine. Using this additional acceleration/velocity/position data, a repeatable calculation can be made to help the agricultural machine do an automated turn-around or “auto-turn” maneuver, without operator input, while the agricultural machine (e.g., the windrower) continues cutting crop along a way-line, or performing other such agricultural tasks along a way-line, solely using the integrated acceleration-based positioning from the system.

When mounting and positioning multiple secondary sensors (e.g., accelerometers/inclinometers) on a windrower machine in this manner, the system has the ability to react and detect stimuli in a time/force domain. Specifically, by being able to view instantaneous acceleration or real-time acceleration on the chassis of the agricultural machine, it is possible to integrate and find instantaneous velocity, and thus instantaneous position (also referred to herein as real-time position). In this manner, the system described herein is used as a form of dead reckoning, except unlike using a wheel displacement method, there is no possibility for error buildup due to wheel slip when traversing on a less-than-ideal medium (e.g., muddy soil). In some embodiments, the system is also configured for collision detection due to the ability to view real-time force imparted by/on the agricultural machine. This advantageously satisfies functional safety criteria for some agricultural machines.

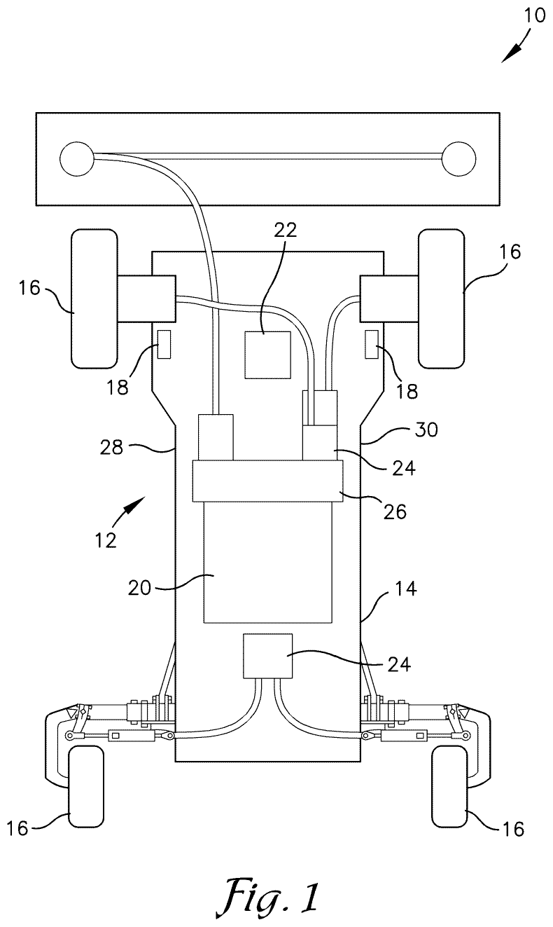

As schematically depicted in FIG. 1, the present invention includes an integrated acceleration-based positioning system 10 including and/or at least partially located on an agricultural machine 12 having a chassis 14 and a plurality of wheels 16 rotatably attached to the chassis 14. The system 10 may be located on and/or at least partially integrated into the agricultural machine 12. In some embodiments, the system 10 includes secondary sensors 18 and a controller 20 communicably coupled with the secondary sensors 18. Furthermore, in some embodiments, the system 10 also includes at least one global positioning sensor 22, such as a GPS sensor or antenna.

The agricultural machine 12 may be a windrower machine, tractor, or other such agricultural equipment configured to travel over a field, road, or pathway. For example, a windrower machine is known in the art as a vehicle having an implement for crop cutting and laying stalks in windrows for later threshing and cleaning. However, the agricultural machine 12 may be any vehicle with a chassis without departing from the scope of the invention described herein.

The chassis 14 of the agricultural machine 12 may be a frame upon which other components are supported, including a vehicle cap, the system 10, and other components described herein. The chassis 14 may have a left half and a right half on opposing sides of a longitudinal axis extending along a length of the chassis (e.g., where the axis is equidistant from left and right wheels 16 of one or more of the depicted pairs of wheels 16). The wheels 16 may include two wheels, three wheels, four wheels, or even more in some embodiments of the invention. For example, the agricultural machine 12 may have left wheels and right wheels, including a left front wheel, a left back wheel, a right front wheel, and a right back wheel, each rotatably coupled with the chassis 14 via a rotatable axle or some other mechanical rotational connectors.

The agricultural machine 12, in addition to the chassis 14 and the wheels 16, may include a drive system 24 operable to rotate at least some of the wheels 16 for propulsion of the agricultural machine 12. Furthermore, in some embodiments, the agricultural machine 12 may include a navigation system 26. The navigation system 26 is communicably coupled with the controller 20. In some embodiments, the navigation system 26 is integrated into the controller 20 and/or is a combination of hardware and software components separate from the controller 20. The navigation system 26 may be, for example, an automated guidance system communicably coupled to the drive system 24 or a user-guided navigation system communicably coupled with a user interface display, such as a display located within a cab of the agricultural machine 12. The automated guidance system may communicate with the drive system 24 and other systems of the agricultural machine 12 such that the agricultural machine 12 is self-propelled through the field. While the drive system 24 and the navigation system 26 are depicted as being located on the agricultural machine 12, some components of the drive system 24 and/or the navigation system 26 may be located remotely and communicably coupled with the controller 20 and/or other components of the agricultural machine 12.

In some embodiments, the agricultural machine 12 is configured such that the wheels 16 can operate independently of each other in order to perform zero-radius turns (also referred to herein as zero-turn maneuvers). For example, the agricultural machine 12 may be a self-propelled agricultural machine capable of zero radius turning, as described in U.S. Pat. No. 9,930,824, incorporated by reference herein in its entirety. To perform a zero-radius turn, the agricultural machine 12 and/or the chassis thereof stays essentially in the same geographic location while the agricultural machine 12 changes headings/turns around. For example, the left wheels rotate forward while right wheels rotate in reverse at the same displacement and at the same velocity so that the agricultural machine 12 turns in place and then the agricultural machine 12 travels back exactly in the same direction from whence the agricultural machine 12 came. This turning-in-place type maneuver can cause miscues with global positioning or GPS readings from the global positioning sensor 22 in some instances. Thus, the secondary sensors 18 in the system 10 can be used to supplement the global positioning readings from the global positioning sensor 22, particularly during high-speed, low positional change rotational turns by the agricultural machines 12.

The secondary sensors 18 are located on opposing left and right halves of the chassis 14, on either side of a longitudinal axis of the chassis. For example, the secondary sensors 18 may respectively be fixed to locations just inside left- and right-margins of the chassis 14 or outboard on the chassis 14, proximate to right and left opposing ones of the wheels 16. In some embodiments, there may be two sensors 18 located on the chassis 14 near right and left front wheels or right and left rear wheels of the agricultural machine 12. Additional secondary sensors 18 may also be used in some embodiments. For example, there may be two, four, six, or eight secondary sensors 18 without departing from the scope of the invention. In some embodiments, the secondary sensors 18 are located as far away from the longitudinal axis (also referred to as a rotational axis of the chassis 14) as possible so that the secondary sensors 18 can determine the largest amount of rotational differential experienced by different outermost portions of the chassis 14. For example, the secondary sensors 18 may each be located at or within one to two feet from opposing edges 28,30 of the chassis and/or within one to two feet from the right and left opposing ones of the wheels 16. While some alternative embodiments may use only one of the secondary sensors 18, having two secondary sensors 18 mounted on opposing sides of the chassis 14 allows for a two-dimensional reference of where each side of the chassis 14 is in terms of the chassis' acceleration.

The secondary sensors 18 may each include a multi-axis accelerometer. In some embodiments, the secondary sensors 18 may additionally include an inclinometer and/or gyroscope. In some embodiments, the sensors 18 each combine a 3-axis accelerometer, a 3-axis gyroscope and a geomagnetic sensor or magnetometer in a small single-sensor housing. For example, each of the sensor 18 may be a BMF055, BNO055, or BMX160 made by ROBERT BOSCH GMBH of Gerlingen, Germany (BOSCH® is a registered trademark of Robert Bosch GMBH). However, other multi-axis sensors may be used without departing from the scope of the invention. Output sensed by the secondary sensors 18 may be configured to individually and/or cooperatively determine acceleration, inclination, roll, pitch, yaw, velocity, and other motion-based characteristics. Roll, pitch, and yaw can be used in a number of traditional ways by the system 10. For example, roll may be indicated on a hilly terrain if there are tilt issues, and the controller 20 can respond by outputting warnings to the navigation system or various user interfaces or warning indicators of the agricultural machine 12.

In some embodiments, the controller 20 and/or components thereof may be located within the housing of the sensors themselves. For example, the BMF055 sensor includes an accelerometer, a gyroscope, a magnetometer and a microcontroller in a single housing, and at least some of the functions described in the method steps below may be programmed into the microcontroller. However, in other embodiments, the controller 20 is communicably coupled to each of the sensors 18 and may be remotely located within a cab of the agricultural machine 12 or at some other location remote from the sensors 18.

The controller 20 may be programmed to perform documented dynamic motion equations using readings from the global positioning sensors 22 and/or the sensors 18 in order to determine a heading of the agricultural machine 12, as well as other characteristics thereof, such as acceleration, geographic location, terrain features, and/or collisions. The guidance may be used by the controller as primary position information for the system 10, and then alternatively during a zero-radius turn or a zero turn maneuver, the controller 20 may be configured to switch to using information from the sensors 18 to solve for an accurate rate of heading change or instantaneous real-time position of the chassis 14 in the field. For example, the controller 20 may use arc length along a curve and tangential acceleration instantaneously to get an accurate rate of heading change on a polar coordinate system. In some embodiments, the drive system 24 and/or the navigation system 26 (e.g., an automated guidance system or a user-guided navigation system) is communicably coupled with the controller 20, and the controller 20 is configured to output instructions to those and other systems of the agricultural machine 12 based on signals received from the global positioning sensor 22 and/or the secondary sensors 18, as later described herein.

The controller 20 is communicably coupled with the global positioning sensor 22, the secondary sensors 18, the drive system 24, and the navigation system 26, among other systems of the agricultural machine 12. The controller 20 may include at least one processor, at least one memory element, circuitry, communication components, and the like. The processor may comprise one or more processors. The processor may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processor may generally execute, process, or run instructions, code, code segments, code statements, software, firmware, programs, applications, apps, processes, services, daemons, or the like. The processor may also include hardware components such as registers, finite-state machines, sequential and combinational logic, configurable logic blocks, and other electronic circuits that can perform the functions necessary for the operation of the current invention. In certain embodiments, the processor may include multiple computational components and functional blocks that are packaged separately but function as a single unit. In some embodiments, the processor may further include multiprocessor architectures, parallel processor architectures, processor clusters, and the like, which provide high performance computing. The processor may be in electronic communication with the other electronic components of the system 10 through serial or parallel links that include universal busses, address busses, data busses, control lines, and the like.

The processor may be operable, configured, or programmed to perform the following functions, processes, or methods by utilizing hardware, software, firmware, or combinations thereof. Other components, such as the communication components and the memory element may be utilized as well.

The memory element may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element may be embedded in, or packaged in the same package as, the processor. The memory element may include, or may constitute, a non-transitory “computer-readable medium”. The memory element may store the instructions, code, code statements, code segments, software, firmware, programs, applications, apps, services, daemons, or the like that are executed by the processor. The memory element may also store data that is received by the processor or the controller 20 in which the processor is implemented. The processor may further store data or intermediate results generated during processing, calculations, and/or computations as well as data or final results after processing, calculations, and/or computations. In addition, the memory element may store settings, text data, documents from other software applications, databases, and the like.

The global positioning sensor 22 (also referred to herein as GPS) may is configured to send geographic location signals to the controller 20. In one or more embodiments, the global positioning sensor 22 may comprise a satellite navigation receiver that works with a global navigation satellite system (GNSS) such as the global positioning system (GPS) operated by the United States, the GLONASS system operated the Soviet Union, or the Galileo system operated by Europe. As is known in the art, the global positioning sensor 22 may utilize a plurality of satellites in orbit about the Earth. The global positioning sensor 22 receives the spread spectrum GPS satellite signals from the various satellites and calculates the global position or geographic location of the global positioning sensor 22 as a function of the signals.

In some embodiments, the system 10 described herein can be used to retrofit the agricultural machine 12. For example, the secondary sensors 18 can be mounted onto the chassis 14 in the locations described above and the controller 20 can be added anywhere within the agricultural machine 12 or an existing controller can be programmed to communicate with the secondary sensors 18 and existing global positioning sensors, as well as existing drive systems and/or navigation systems similar to those described above, such that the controller operates in accordance with the methods described herein.

In use, the controller 20 is configured to send the geographic location signals received from the global positioning sensor 22 to the automated guidance system or the user-guided navigation system when the geographic location signals are within a pre-determined acceptable range and to send the instantaneous or real-time position of the chassis in the field as calculated from acceleration signals when the geographic location signals received by the controller from the global positioning sensor 22 are outside of the pre-determined acceptable range. Specifically, the geographic location signals from the global positioning sensor 22 are outside of the pre-determined acceptable range when the agricultural machine 12 is traveling along a high-speed, low radius of curvature turn (like the zero-radius turns described herein).

In some embodiments, the system 10 is also configured to determine instantaneous or real-time heading and/or that a collision has occurred. The real-time positions in the field are by default determined by the controller 20 based on the geographic location signals from the global positioning sensor 22; this is referred to herein as the default mode of the controller 20. Otherwise, the real-time positions in the field are determined based on the acceleration signals from the secondary sensors 18 when specific triggering fault conditions are sensed by the controller 20; this is referred to herein as the back-up mode. These fault conditions may include when the global positioning sensor 22 provides geographic location signals that do not make sense, are outside of the pre-determined acceptable range, or are not within a margin of error compared with the real-time position in the field calculated based on signals from the secondary sensors 18. In some embodiments, the controller 20 may remain in the back-up mode for a short, pre-determined length of time (e.g., 15-30 msec), then switch back to the default mode if the triggering fault conditions are no longer detected.

Unlike using the wheel displacement method as a back-up to the global positioning sensor 22, even when the wheels are slipping in mud, the chassis 14 (and thus the secondary sensors 18 thereon) would experience a drop in acceleration or an advancement in acceleration. Thus, the acceleration of the chassis 14 from the secondary sensors 18 may in some triggering fault conditions be more reliable than that of the wheels in wheel displacement methods.

Furthermore, the system 10 may be used to determine that a collision has occurred. Specifically, the controller 20 can receive information from the secondary sensors 18 that indicates there is a high acceleration differential in a pre-determined short amount of time above a threshold amount of acceleration differential allowed. This indicates that the agricultural machine 12 came to a stop more quickly than it should be able to, and a collision warning may thus be provided to a user and/or the agricultural machine 12 may be automatically stopped and placed into a safe state. In some embodiments, acceleration in the Z-axis by at least one of the secondary sensors 18 shows that the chassis 14 went over a bump, for example, but if there is a sudden acceleration spike in the x-axis, the agricultural machine 12 may have hit something going forward or in reverse, indicating a collision.

By contrast, many agricultural machines such as tractors and windrowers traditionally do not have collision detection and as long as its hydrostat handle is pushed forward, the tractor or windrower keeps going regardless of what is in its path. The redundancy and functional safety provided by the system 10 described herein reduces risk to an operator and defaults to safe conditions when sensing items like collision, for example.

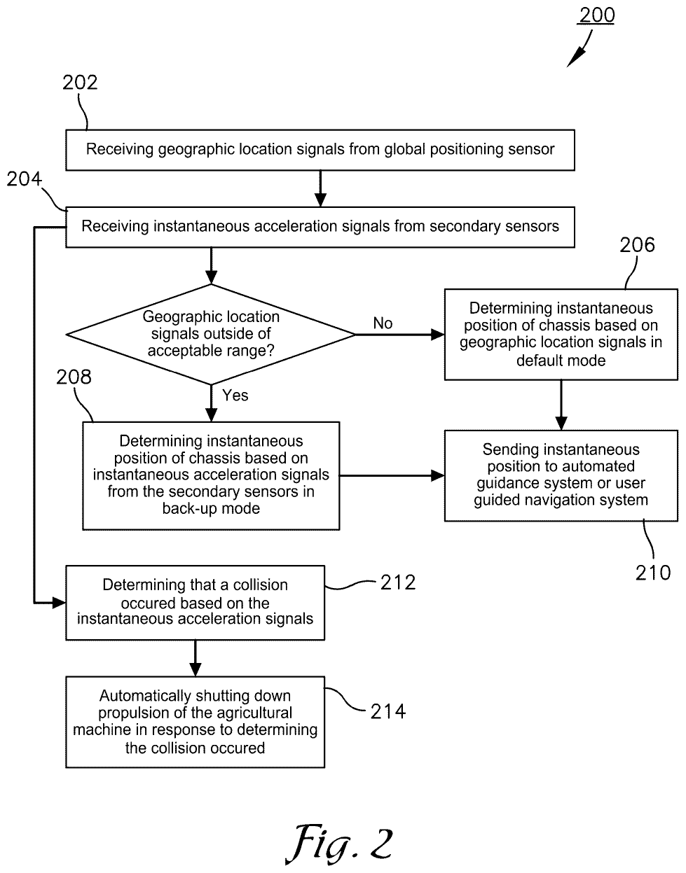

FIG. 2 depicts a listing of at least a portion of the steps of an exemplary computer-implemented method 200 for accurately guiding the agricultural machine through a field. The steps may be performed in the order shown in FIG. 2, or they may be performed in a different order. Furthermore, some steps may be performed concurrently as opposed to sequentially. In addition, some steps may be optional or may not be performed. The steps may be performed by the processor or other portions of the controller 20 via hardware, software, firmware, or combinations thereof. Furthermore, the steps may be implemented as instructions, code, code segments, code statements, a program, an application, an app, a process, a service, a daemon, or the like, and may be stored on a computer-readable storage medium, such as the memory element described above.

The method 200 may include the steps of receiving geographic location signals from the global positioning sensor 22, as depicted in block 202, and receiving acceleration signals from at least two of the secondary sensors 18 located on opposing left and right halves of the chassis 14, as depicted in block 204. The acceleration signals may be real-time or instantaneous acceleration signals. Next, the method 200 may include the steps of determining an instantaneous or real-time position of the chassis based on the geographic location signals in a default mode, as depicted in block 206, and determining the instantaneous or real-time position of the chassis based on the acceleration signals when the geographic location signals are outside of a pre-determined acceptable range, as depicted in block 208, referred to herein as back-up mode.

The instantaneous acceleration signals may be used to determine the instantaneous position using integration, such as Newton's second equation of motion (s=u*t+(½)a*t\hat{ }2) or Euler's approximation method. Specifically, to find velocity from acceleration: v[n]=v[n−1]+t*a[t] and to find position from velocity: x[n]=x[n−1]+t*v[n−1]. Other methods for determining such values can use Stormer-Verlet Integration or using 4th Order Runga Kutta, both of which may improve accuracy. Stormer-Verlet Integration uses central difference approximation to the second derivative and allows the discovery of the next position vector using the previous two data points, which can improve approximation accuracy over some alternative methods. Störmer-Verlet Integration may be used as follows:

To find velocity step from acceleration:v[n+1]=v[n+½]+2Δt*a[n+1]

To find position step from velocity:x[n+1]=x[n]+t*v[n+½]

The 4th Order Runga Kutta is a weighted, iterative approximation that can additional or alternatively be used in the method steps herein, but can increase computational load. For example, to find position, create iterative matrix:

Calculate the Slope (Derivative) at Multiple Points within the Time Step:

k1v=t*a(x[n],v[n])

k1x=t*v[n]

k2v=t*a(x[n]+k1x/2,v[n]+k1v/2)

k2x=t*(v[n]+k1v/2)

k3v=t*a(x[n]+k2x/2,v[n]+2k2v)

k3x=t*(v[n]+k2v/2)

k4v=t*a(x[n]+k3x,v[n]+k3v)

k4x=t*(v[n]+k3v)

### Calculate Velocity and Position:

v[n+1]=v[n]+⅙*(k1v+2k2v+2k3v+k4v)

x[n+1]=x[n]+⅙*(k1x+2k2x+2k3x+k4x)

Note that the equations provided above are merely examples of the types of equations that can be implemented in the system described herein. Other such equations and algorithms can be used without departing from the scope of the invention as described herein.

The geographic location signals received by the controller may be considered outside of the pre-determined acceptable range when the agricultural machine is making a high-speed, low radius of curvature turn. A number of other triggering faults may also trigger the use of the secondary sensors 18 instead of the global positioning sensor 22. One example metric that may be used for this “high-speed” threshold is a heading rate of change of >30 degrees per second. In some embodiments, a “low-radius” definition, in reference to the machine 12, is defined as a turn that has a radius less than half the width of the machine frame. More specifically, half the machine tire width, which may be, in some examples, approximately 3.378 meters distance.

Erroneous readings or other triggers in which the secondary sensors 18 are used instead of the global positioning sensors 22 may include situations in which the global positioning sensors 22 indicates to a model representation on the system's user interface display or monitor that the machine 12 inexplicably starts turning the opposite direction of what the machine 12 would be doing in reality. For example, the machine 12 comes to a stop, then proceeds to execute a 180 degree zero turn. The global positioning sensors 22 does not have the precision to determine which direction the machine 12 is rotating, because the positional change for the receiver unit is only a few inches at most, and secondarily, the global positioning sensors 22 is rotating about a point, not traveling in a straight line. So, the global positioning sensors 22 may attempt to make something up, because it is aware something is happening, just not quite clear on what is happening. What the global positioning sensors 22 come up with is reflected on the user interface display or monitor. The model of the machine 12 on the user interface display or monitor might still track accurately at first for about 45 degrees of the rotation, but then randomly start rotating the wrong way, or immediately change heading to something random like 270 degrees. The system described herein may thus determine under such example erroneous scenarios to determine the instantaneous or real-time position of the chassis based on the acceleration signals instead, as in block 208, since it is clear that the geographic location signals and/or the heading changes within a given length of time are outside of the expected range or the pre-determined acceptable range.

The method 200 may also include a step of sending the real-time position of the chassis to an automated guidance system or a user-guided navigation system, as depicted in block 210, for guiding the agricultural machine 12 through a field. The steps depicted in blocks 202-210 may repeat substantially continuously or in small increments of time, such as 10-30 msec. The system 10 may operate in accordance with the default mode unless the geographic location signals are outside of the acceptable range. However, once the geographic location signals are back within the acceptable range, the system 10 may return to the default mode.

Finally, the method 200 may include the steps of determining that a collision occurred based on the acceleration signals, as depicted in block 212, and automatically shutting down propulsion of the agricultural machine 12, as depicted in block 214, when the controller 20 determines the collision occurred. The controller 20, for example, may compare one or more of the previous acceleration signals with a most recent one of the acceleration signals and determine that the change in acceleration is too great for such a short period of time and/or changed directions too suddenly, thus indicating a collision. Shutting down propulsion of the agricultural machine 12 within the field may include shutting off an engine of the agricultural machine 12, actuating breaks of the wheels 16, pausing the drive system 26 in some other way, or otherwise ceasing movement of the agricultural machine 12 in any direction on the field. The step depicted in block 214 may include shutting down forward and/or rearward propulsion.

Throughout this specification, references to “one or more embodiments”, “an embodiment”, or “embodiments” mean that the feature or features being referred to are included in at least one or more embodiments of the technology. Separate references to “one or more embodiments”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one or more embodiments may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processor,” “processing element,” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. An agricultural machine operable to perform a zero-radius turn and operable for guided or automated travel through a field, the agricultural machine comprising:
a chassis having a left half and a right half;
a plurality of wheels rotatably coupled to the chassis;
a first multi-axis accelerometer mounted on the left half of the chassis and a second multi-axis accelerometer mounted on the right half; and
a controller configured to receive acceleration signals from the first and second multi-axis accelerometers and to calculate a position of the chassis in the field based on the acceleration signals received from the multi-axis accelerometers.

2. The agricultural machine of claim 1, further comprising a global positioning sensor configured to send geographic location signals to the controller.

3. The agricultural machine of claim 2, further comprising an automated guidance system or a user-guided navigation system communicably coupled with the controller, wherein the controller is configured to send the geographic location signals received from the global positioning sensor to the automated guidance system or the user-guided navigation system when the geographic location signals are within a pre-determined acceptable range and to send the position of the chassis in the field as calculated from the acceleration signals when the geographic location signals received by the controller from the global positioning sensor are outside of the pre-determined acceptable range.

4. The agricultural machine of claim 3, wherein the controller is configured to determine that the geographic location signals received by the controller are outside of the pre-determined acceptable range by determining that the agricultural machine is making a high-speed, low radius of curvature turn.

5. The agricultural machine of claim 1, wherein the agricultural machine is a windrower machine.

6. The agricultural machine of claim 1, further comprising a drive system of the agricultural machine communicably coupled with the controller, wherein the controller is configured for determining if a collision occurred based on the instantaneous acceleration signals and to automatically shut down propulsion of the agricultural machine via the drive system when the controller determines the collision occurred.

7. The agricultural machine of claim 1, wherein each of the multi-axis accelerometers comprises at least a three-axis accelerometer.

8. The agricultural machine of claim 1, wherein, to calculate the instantaneous position of the chassis in the field, the controller is configured to use an arc length along a curve and tangential acceleration instantaneously from the multi-axis accelerometers to calculate an accurate rate of heading change on a polar coordinate system.

9. The agricultural machine of claim 1, wherein the multi-axis accelerometers are located at opposing edges of the chassis.

10. The agricultural machine of claim 1, wherein the multi-axis accelerometers further include an inclinometer or a gyroscope or both the inclinometer and the gyroscope.

11. The agricultural machine of claim 1, wherein the multi-axis accelerometers are fixed to the chassis proximate to opposing ones of the plurality of wheels.

12. A windrower machine operable to perform a zero-radius turn, the windrower machine comprising:
a chassis having a left half and a right half;
a plurality of wheels rotatably coupled to the chassis;
a global positioning sensor configured to output geographic location signals;
a secondary sensor comprising a three axis accelerometer mounted on the left half and a secondary sensor comprising another three axis accelerometer mounted on the right half; and
a controller configured to receive geographic location signals from the global positioning sensor and acceleration signals from the secondary sensors and to calculate a real-time position of the chassis in a field based on the acceleration signals received from the secondary sensors when the geographic location signals are outside of a pre-determined acceptable range.

13. The windrower machine of claim 12, wherein the controller is configured to determine that the geographic location signals are outside of the pre-determined acceptable range by determining that the windrower is making a high-speed, low radius of curvature turn or a zero-radius turn.

14. The windrower machine of claim 12, further comprising a drive system of the windrower machine communicably coupled with the controller, wherein the controller is configured to determine if a collision occurred based on signals received from the secondary sensors and to automatically shut down propulsion of the windrower machine via the drive system when the controller determines the collision occurred.

15. The windrower machine of claim 12, wherein the controller is further configured to determine the real-time position of the chassis in the field based on signals received from the global positioning sensor once the signals received by the controller from the global positioning sensor are again within the pre-determined acceptable range.

16. The windrower machine of claim 12, wherein the secondary sensors further include an inclinometer or a gyroscope or both the inclinometer and the gyroscope.

17. The windrower machine of claim 12, wherein the secondary sensors are located at opposing edges of the chassis.

18. A method for accurately guiding an agricultural machine through a field, the method comprising:
receiving, with a controller, geographic location signals from a global positioning sensor located on the agricultural machine;
receiving, with the controller, acceleration signals from two three-axis accelerometers respectively located on opposing left and right halves of a chassis of the agricultural machine;
determining, with the controller, a real-time position of the chassis based on the geographic location signals in a default mode;
determining, with the controller, the real-time position of the chassis based on the acceleration signals when the geographic location signals are outside of a pre-determined acceptable range; and
sending the real-time position of the chassis to an automated guidance system or a user-guided navigation system communicably coupled with the controller for guiding the agricultural machine through the field.

19. The method of claim 18, wherein the controller determines that the geographic location signals received by the controller are outside of the pre-determined acceptable range if the controller determines that the agricultural machine is making a high-speed, low radius of curvature turn.

20. The method of claim 18, further comprising determining, with the controller, that a collision occurred based on the acceleration signals and automatically shutting down propulsion of the agricultural machine when the controller determines the collision occurred.
